(19) United States
(12) Patent Application Publication
(10) Pub. No.: US 2009/0301882 A1
(43) Pub. Date: Dec. 10, 2009

(54) IONTOPHORESIS DEVICE

(76) Inventors: Takehiko Matsumura, Tokyo (JP); Kiyoshi Kanamura, Tokyo (JP); Mizuo Nakayama, Tokyo (JP); Hidero Akiyama, Tokyo (JP); Akihiko Matsumura, Shibuya-ku (JP)

Correspondence Address: SEED INTELLECTUAL PROPERTY LAW GROUP PLLC, 701 FIFTH AVE, SUITE 5400, SEATTLE, WA, 98104, US

(21) Appl. No.: 11/917,497

(22) PCT Filed: Aug. 1, 2006
(86) PCT No.: PCT/JP2006/315190

§ 371 Date: Aug. 10, 2009

(30) Foreign Application Priority Data
Aug. 1, 2005 (JP) 2005-222893

(51) Int. Cl. C02F 1/469

(52) U.S. Cl. 204/537

(57) ABSTRACT

An iontophoresis device may include an electrolyte solution holding portion and a drug solution holding portion. The electrolyte solution holding portion holds a solution of an electrolyte that dissociates into a first electrolytic ion of a first polarity type and a second electrolytic ion of a second polarity type in a solution. The drug solution holding portion holds a solution of a drug that dissociates into a drug ion of the first polarity type and a drug counter ion of the second polarity type. The iontophoresis device may also include a first ion exchange membrane with an ion exchange group of the first polarity type and a second ion exchange membrane with an ion exchange group of the second polarity type. The first and the second ion exchange members interpose the electrolyte solution holding portion and the drug solution holding portion.

### CROSS-REFERENCES TO RELATED APPLICATIONS

This application also claims benefit of priority under 35 U.S.C. § 119 to U.S. Provisional Application No. 60/717,873, filed Sep. 15, 2005.

### BACKGROUND

1. Technical Field

The present disclosure relates to an iontophoresis device having an active assembly including a drug solution holding portion and an electrolyte solution holding portion. The iontophoresis device configured to suppress an alteration of a drug solution in the drug solution holding portion.

2. Description of the Related Art

Iontophoresis employs an electromotive force and/or current to transfer an active agent (e.g., a charged substance, an ionized compound, an ionic a drug, a therapeutic, a bioactive-agent, and the like), to a biological interface (e.g., skin, mucus membrane, and the like), by applying an electrical potential to an electrode proximate an iontophoretic chamber comprising a similarly charged active agent and/or its vehicle. For example, a positively charged ion may be transferred into the skin at an anode side of an electric system of an iontophoresis device. In contrast, a negatively charged ion may be transferred into the skin at a cathode side of the electric system of the iontophoresis device.

Japan Patent Application JP 3040517 B and Patent Cooperation Treaty publication WO 03/037425 each disclose a conventional iontophoresis device for administering an ion-dissociating drug whose drug component dissociates into drug ions of a positive or negative polarity type.

FIG. 1 is an explanatory view schematically showing the constitution of a conventional iontophoresis device 10 such as the types disclosed in each of Japan Patent Application JP 3040517 B and Patent Cooperation Treaty publication WO 03/037425. The conventional iontophoresis device 10 includes an electrode member 11 and an electrolyte solution holding portion 12 that holds an electrolyte solution. In a solution, the electrolyte of the electrolyte solution dissolves and dissociates into a first electrolytic ion (E⁺) of a first polarity type and a second electrolytic ion (E⁻) of a second polarity type. The electrolyte solution is dissolved and is adapted remain in contact with the electrode member 11.

The conventional iontophoresis device 10 also includes an ion exchange membrane 13 selected from an ion exchange group of the second polarity type. A surface of the ion exchange membrane 13 is placed on a front surface side (skin side) of the electrolyte solution holding portion 12.

The conventional iontophoresis device 10 also includes a drug solution holding portion 14 that holds a drug solution. In a solution, a drug of the drug solution dissolves and dissociates into a drug ion (D⁺) of the first polarity type and a drug counter ion (D⁻) of the second polarity type. The drug solution holding portion 14 is placed on a front surface side of the ion exchange membrane 13.

The conventional iontophoresis device 10 further includes an ion exchange membrane 15 selected from an ion exchange group of the first polarity type. The ion exchange membrane 15 is placed on a front surface side of the drug solution holding portion 14.

When a voltage having a polarity of the first polarity type (positive in the example shown in FIG. 1) is applied to the electrode member 11, the ion exchange membrane 15 suppresses the passage of an ion of the second polarity type while permitting the passage of an ion of the first polarity type. Thus, the drug ion (D⁺) is administered to an organism (a human being or an animal) through the ion exchange membrane 15, while the transfer of a biological counter ion (B⁻) to the drug solution holding portion 14 is suppressed. (As a result, the efficiency of administration of the drug ion increases. The biological counter ion (B⁻) may be an ion present on the surface of an organism or in the organism, which has the polarity type opposite to that of the drug ion.

The ion exchange membrane 13 suppresses the passage of an ion of the first polarity type while permitting the passage of an ion of the second polarity type. Thus, the transfer of the drug ion (D⁺) to the electrolyte solution holding portion 12 and the transfer H⁺ ions that may be generated near the electrode member 11 to the drug solution holding portion 14 are suppressed. In addition, the production of a harmful substance and an abrupt fluctuation in pH value at a skin interface due to the decomposition of the drug near the electrode member 11 are prevented.

However, research conducted by the inventors of the instant application has revealed that the conventional iontophoresis device 10 may cause phenomena such as color change of the drug solution, precipitation of a crystal in the drug solution holding portion 14, a reduction in drug effect, and/or the production of a harmful substance due to the alteration of the drug. The production of the harmful substance may be a function of the degree of time that has elapsed since the time iontophoresis device 10 was assembled, on the kind of the electrolyte used, the kind of the drug, and a combination thereof. Furthermore, the conventional iontophoresis device 10 may cause the above listed phenomena even in the case where a stable drug that does not alter over a long time period is used.

In Japan Patent Application JP 2004-347814 A, the inventors of the instant application have disclosed a porous separation membrane that is placed between an electrolyte solution holding portion and a drug solution holding portion. The porous separation membrane has small pores, i.e., the pores are of appropriate size to permit the passage of a drug counter ion while suppressing the passage of the second electrolytic ion. The porous separation membrane is of appropriate molecular weight cut-off to achieve compatibility between the suppression of the occurrence of each of the above phenomena in the drug solution holding portion and the securement of energization necessary for the administration of a drug.

However, it may be difficult to obtain a porous separation membrane satisfying the above property depending on the kind of an electrolyte to be held by the electrolyte solution holding portion and the kind of a drug to be held by the drug solution holding portion. In addition, it is not easy to uniformly maintain the size of a small pore in the porous separation membrane in all production lots.

A problem with conventional iontophoresis devices is the lifespan of the active assembly, which degrades over time. Thus, conventional iontophoresis devices cannot be stored indefinitely. Quality control of the porous separation membrane must be managed with some degree of stringency to obtain a desired lifespan.

Thus, there is a need for an iontophoresis device that has a lifespan of predetermined duration.

Thus, there is a need for an iontophoresis device that suppresses or prevents color change of a drug solution; precipitation of a crystal in a drug solution holding portion; reduction in drug effect; or production of a harmful substance due to the alteration of a drug.

There is a need for an iontophoresis device that prolongs the period of time without the occurrence of color change of a drug solution over that of a conventional iontophoresis device.

There is a need for an iontophoresis device that prolongs the period of time without the occurrence of precipitation of a crystal in a drug solution holding portion over that of a conventional iontophoresis device.

There is a need for an iontophoresis device that prolongs the period of time without the occurrence of reduction in drug effect over that of a conventional iontophoresis device.

There is a need for an iontophoresis device that prolongs the period of time without the occurrence of production of a harmful substance due to the alteration of a drug over that of a conventional iontophoresis device.

### BRIEF SUMMARY

In one aspect, an iontophoresis device includes an electrolyte solution holding portion and a drug solution holding portion. The electrolyte solution holding portion has a front surface and a back surface and holds a solution of an electrolyte that dissociates into a first electrolytic ion of a first polarity type and a second electrolytic ion of a second polarity type in a solution, wherein the first polarity type and the second polarity type are of opposite polarity. In operable position, the front surface of the electrolyte solution holding portion is proximal to a user and the back surface is distal from the user. The drug solution holding portion holds a solution of a drug that dissociates into a drug ion of the first polarity type and a drug counter ion of the second polarity type. The drug solution holding portion is proximal to the front surface side of the electrolyte solution holding portion. The iontophoresis device also includes a first ion exchange membrane with an ion exchange group of the first polarity type and a second ion exchange membrane with an ion exchange group of the second polarity type. The first and the second ion exchange members interpose the electrolyte solution holding portion and the drug solution holding portion.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a plan view of a conventional iontophoresis device.

FIGS. 2A and 2B are cross sectional views of a iontophoresis device according to one non-limiting illustrated embodiment.

FIG. 3 is a cross sectional view of another iontophoresis device according to one non-limiting illustrated embodiment.

FIGS. 4A-4E are cross sectional views of various embodiments of an active assembly according to respective illustrated embodiments.

FIGS. 5A-5C are cross sectional views of various additional embodiments of an active assembly according to respective illustrated embodiments.

FIGS. 6A-6D are cross sectional views of various additional embodiments of an active assembly according to respective illustrated embodiments.

FIGS. 7A and 7B are cross sectional views of various embodiments of a counter-balance assembly according to respective illustrated embodiments.

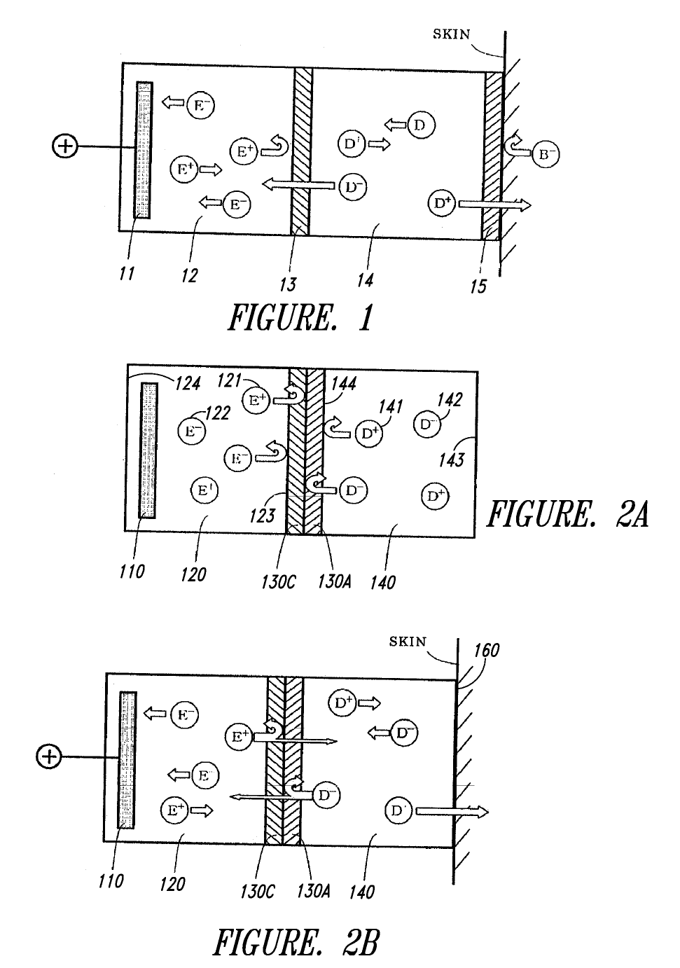

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with computing systems, networks including servers, routers, bridges, firewalls, etc., and gaming device including electronic gaming machines have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Further more, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

The headings and Abstract of the Disclosure provided herein are for convenience only and do not interpret the scope or meaning of the embodiments.

The term “drug” as used herein refers to a substance which may be or may not be prepared, which has a certain drug effect or pharmacological effect, and which is applicable to an organism (a human being or an animal) for purposes including the therapy, recovery, and prevention of a disease and the promotion and maintenance of the health.

The term “drug ion” as used herein refers to an ion which is produced by the dissociation of a drug to ions and which is responsible for a drug effect or a pharmacological action, and the term “drug counter ion” as used herein refers to a counter ion of the drug ion. The dissociation of the drug to a drug ion and a drug counter ion may occur as a result of the dissolution of the drug into a solvent such as water, an alcohol, an acid, or an alkali, or may occur as a result of, for example, the application of a voltage or the addition of an ionizing agent.

The term “first polarity type” as used herein refers to positive or negative electrical polarity, and the term “second polarity type” as used herein refers to an electrical polarity (positive or negative) that is opposite to the first polarity type.

As described herein below, in some embodiments, an iontophoresis device may be capable of preventing or suppressing: color change of a drug solution; precipitation of a crystal in a drug solution holding portion; reduction in drug effect; or production of a harmful substance due to the alteration of a drug.

As described herein below, in some embodiments, the iontophoresis device may still be capable of preventing or suppressing: color change of a drug solution; precipitation of a crystal in a drug solution holding portion; reduction in drug effect; or production of a harmful substance due to the alteration of a drug for at least a predetermined period of time.

As described herein below, in some embodiments, when a drug is administered after an iontophoresis device has been retained for a certain time period or longer, the iontophoresis device may be capable of preventing or suppressing a reduction in efficiency of administration of the drug.

As described herein below, in some embodiments, when a drug is administered after an iontophoresis device has been retained for a certain time period or longer, the iontophoresis device may be capable of preventing or suppressing decomposition of the drug in an electrolyte solution holding portion, or the production of a harmful substance due to the decomposition.

As described herein below, in some embodiments, an iontophoresis device may include two electrolyte holding portions and may be capable of preventing or suppressing a change in composition in each of two electrolyte solution holding portions.

As described herein below, in some embodiments, an iontophoresis device may include an active assembly and a counter-balance assembly and may be capable of having a long lifetime such that the iontophoresis device may be distributed, stored, and the like with the iontophoresis device having the active assembly and the counter-balance assembly assembled.

As described herein below, in some embodiments, an iontophoresis device may include an active assembly and may be capable of having a long lifetime such that the iontophoresis device may be distributed, stored, and the like with the iontophoresis device having the active assembly assembled.

As described herein below, in some embodiments, an iontophoresis device may include a counter-balance assembly and may be capable of having a long lifetime such that the iontophoresis device may be distributed, stored, and the like with the iontophoresis device having the counter-balance assembly assembled.

FIGS. 2A and 2B show an iontophoresis device 100 according to one non-limiting illustrated embodiment. The iontophoresis device 100 includes an active assembly 105, which includes an electrode member 110 and an electrolyte solution holding portion 120 having a skin facing surface 123 and an opposed back surface 124. The electrolyte solution holding portion 120 holds a solution of an electrolyte. In a solution, the electrolyte dissociates into a first electrolytic ion 121 of a first polarity type and a second electrolytic ion 122 of a second polarity type, which is opposite of the first polarity type.

The active assembly 105 also includes a drug solution holding portion 140 having a skin facing surface 143 and an opposed back surface 144. The drug solution holding portion 140 holds a solution of a drug. In a solution, the drug dissociates into a drug ion 141 of the first polarity type and a drug counter ion 142 of the second polarity type.

The skin facing surface 123 of the electrolyte solution holding portion 120 may be arranged to be proximal to the back surface 144 of the drug solution holding portion 140. A first ion exchange membrane 130C and a second ion exchange membrane 130A interpose the skin facing surface 123 of the electrolyte solution holding portion 120 and the back surface 144 of the drug solution holding portion 140. The first ion exchange membrane 130C may be disposed adjacent the back surface 144 of the drug solution holding portion 140, and the second ion exchange membrane 130A may be disposed adjacent the skin facing surface 123 of the electrolyte solution holding portion 120.

The first ion exchange membrane 130C may be selected from an ion exchange group of the first polarity type. Similarly, the second ion exchange membrane 130A may be selected from an ion exchange group of the second polarity type.

Each of the first electrolytic ion 121 and the second electrolytic ion 122 in the electrolyte solution of the electrolyte solution holding portion 120 need not be of a single kind, and one or both of the ions may be of multiple kinds.

Similarly, each of the drug ion 141 and the drug counter ion 142 in the drug solution holding portion 140 need not be of a single kind, and one or both of the ions may be of multiple kinds.

The transfer of the second electrolytic ion 122 to the drug solution holding portion 140 may be prevented by an electrical action of an ion exchange group introduced to the first ion exchange membrane 130C. Therefore, the transfer of the second electrolytic ion may be suppressed without a hitch irrespective of the kind of an electrolyte or drug to be held by the electrolyte solution holding portion 120 or the drug solution holding portion 140. In addition, the transfer of the second electrolytic ion 122 to the drug solution holding portion 140 may be prevented with improved reliability with no need for stringent quality management comparable to that of the porous separation membrane disclosed in Japan Patent Application JP 2004-347814 A.

A transport number of the first ion exchange membrane 130C is defined as a ratio of a charge amount conveyed by the transfer of ions of the first polarity type present in the electrolyte solution holding portion 120 to the drug solution holding portion 140 to the total charge conveyed through the first ion exchange membrane 130C when the first ion exchange membrane 130A is placed between the electrolyte solution holding portion 120 and the drug solution holding portion 120 and a voltage having a polarity of the first polarity type is applied to the electrode member 110 in the electrolyte solution holding portion 120.

A transport number of the second ion exchange membrane 130A is defined as a ratio of a charge amount conveyed by the transfer of ions of the second polarity type present in the drug solution holding portion 140 to the electrolyte solution holding portion 120 to the total charge conveyed through the second ion exchange membrane 130A when the second ion exchange membrane 130A is placed between the electrolyte solution holding portion 120 and the drug solution holding portion 140 and a voltage having a polarity of the first polarity type is applied to the electrode member 110 in the electrolyte solution holding portion 120.

In some embodiments, the second ion exchange membrane 130A may have a transport number higher than that of the first ion exchange membrane 130C.

FIGS. 2A and 2B are now described in greater detail. For the sake of clarity, each one of the first and the second polarity types will be described as having a polarity of positive or negative, respectfully. However, it should be understood that the polarities may be reversed in some embodiments.

FIG. 2A shows the active assembly 105 of the iontophoresis device 100 without a voltage being applied to the electrode member 110. In this example, the electrolyte solution holding portion 120 holds a solution of an electrolyte that dissociates into the first electrolytic ion 121 (E⁺—positive) and the second electrolytic ion 122 (E⁻—negative), which for the remainder of this example are referred to as electrolytic cation 121 and electrolytic anion 122, respectively. The drug solution holding portion 140 holds a solution of a drug that dissociates into the drug ion 141 (D⁺—positive) and the drug counter ion 142 (D⁻—negative), which for the remainder of this example are referred to as drug cation 141 and drug anion 142, respectively. The first ion exchange membrane 130C permits cation exchange, and the second ion exchange membrane 130A permits anion exchange. For the remainder of this example first ion exchange membrane 130C and the second ion exchange membrane 130A are referred to as cation exchange membrane 130C and anion exchange membrane 130A, respectively.

As shown in FIG. 2A, the respective ions in the electrolyte solution holding portion 120 and the drug solution holding portion 140 tend to transfer to the sides of the drug solution holding portion 140 and the electrolyte solution holding portion 120, respectively, by virtue of the action of scattering during storage of the iontophoresis device 100.

However, the transfer of the drug ion 141 to the electrolyte solution holding portion 120 may be inhibited or suppressed by the action of the anion exchange membrane 130A. The suppression of transfer of the drug cation 141 exchange may prevent the drug from decomposing near the electrode member 110, even when the drug is administered after the iontophoresis device 100 has been retained for a long time period.

In addition, the transfer of the electrolytic anion 122 to the drug solution holding portion 140 may be inhibited or suppressed by the action of the cation exchange membrane 130C. The suppression of transfer of the electrolytic anion 122 exchange may prolong the time period in which the iontophoresis device 100 may be retained without the occurrence of each of the following color change of the drug solution, precipitation of a crystal in the drug solution holding portion 140, reduction in drug effect, and the production of a harmful substance due to the alteration of the drug.

The ability to suppress the transfer of the drug cation 141 and the electrolytic anion 142, as described above, may be adjusted depending on, for example, the ion exchange capacity (or the amount of an ion exchange group introduced to the unit area of an ion exchange membrane) of each of the anion exchange membrane 130A and the cation exchange membrane 130C.

FIG. 2B shows the active assembly 105 of the iontophoresis device 100 with a positive voltage being applied to the electrode member 110 and in a state where the skin facing surface 143 of the drug solution holding portion 140 abuts a portion of skin 160 of an organism. In this example, the drug anion 141 is administered into the organism, while the electrolytic cation 141 and the drug anion 142 are attracted to the drug solution holding portion 140 and the electrolyte solution holding portion 120, respectively.

In this case, the cation exchange membrane 130C and the anion exchange membrane 130A may suppress the transfer of the electrolytic anion 121 and the drug cation 142, respectively. The transport number of the cation exchange membrane 130C or the anion exchange membrane 130A may be reduced to some extent, but the drug anion 142 may transfer to the electrolyte solution holding portion 120 or the electrolytic cation 121 may transfer to the drug solution holding portion 140 to the extent that energization necessary for the administration of the drug cation 141 may be secured.

It should be noted that the transport number of the cation exchange membrane 130C or the anion exchange membrane 130A may be adjusted depending on, for example, the kind of an ion exchange group to be introduced to each of the ion exchange membranes 130C and 130A and the ion exchange capacity of each of the membranes.

In addition, it has been found that when the transport number of the cation exchange membrane 130C or the anion exchange membrane 130A may be reduced to the extent that energization property necessary for the administration of the drug cation 141 may be sufficiently secured, the ability to inhibit or suppress the transfer of the drug cation 141 to the electrolyte solution holding portion 120 caused by the anion exchange membrane 130A upon non-energization and the ability to inhibit or suppress the transfer of the electrolytic anion 122 to the drug solution holding portion 140 caused by the cation exchange membrane 130C upon non-energization are sufficiently exerted.

In some embodiments, the cation exchange membrane 130C may be an ion exchange membrane with an ion exchange group of positive polarity type (an exchange group using an ion of the first polarity type as a counter ion) introduced thereto. In some embodiments, the cation exchange membrane 130C may be any cation exchange membrane currently in the market. A cation exchange membrane of a type in which a part or entirety of pores of a porous film is filled with an ion exchange resin with an ion exchange group of the positive polarity type introduced thereto may be used.

In some embodiments, the anion exchange membrane 130A may be an ion exchange membrane with an ion exchange group of the negative polarity type (an exchange group using an ion of the negative polarity type as a counter ion) introduced thereto. In some embodiments, the anion exchange membrane 130A may be any anion exchange membrane currently in the market. An ion exchange membrane of a type in which a part or entirety of pores of a porous film may be filled with an ion exchange resin with an ion exchange group of the negative polarity type introduced thereto may be used. In some embodiments, the anion exchange membrane 130A may be any anion exchange membrane currently in the market. An ion exchange membrane of a type in which a part or entirety of pores of a porous film may be filled with an ion exchange resin with an ion exchange group of the negative polarity type introduced thereto may be used.

The cation exchange membrane 130C and the anion exchange 130A membrane are placed between the electrolyte solution holding portion 120 and the drug solution holding portion 140. The respective membranes are not required to be integrated with the other through adhesion or the like, and the anion and the cation exchange membranes 130A, 130C, respectively, may be arranged or laminated between the electrolyte solution holding portion 120 and the drug solution holding portion 140 prior to the iontophoresis device 100 being used.

Application of a voltage having a polarity of the first polarity type to the active assembly 105 causes the transfer of the drug counter ion 142 from the drug solution holding portion 140 to the electrolyte solution holding portion 120 and/or the transfer of the first electrolytic ion 121 from the electrolyte solution holding portion 120 to the drug solution holding portion 140. As a result, energization to the drug solution holding portion occurs.

However, as the concentration of the first electrolytic ion 121 in the drug solution holding portion 140 increases the efficiency of administration of the drug ion 141 to an organism decreases, particularly in the case where the mobility of the first electrolytic ion 121 may be larger than that of the drug ion 141. In addition, in some cases, it may be desirable that the first electrolytic ion 121 is not transferred to the organism, for example, the first electrolytic ion 121 may be unsafe for the organism.

In some embodiments, the transport number of the second ion exchange membrane 130A may be higher than that of the first ion exchange membrane 130C. In that case, the transfer of the first electrolytic ion 121 from the electrolyte solution holding portion 120 to the drug solution holding portion 140 may be suppressed while the transfer of the drug counter ion 142 from the drug solution holding portion 140 to the electrolyte solution holding portion 120 upon energization increases. Accordingly, a reduction in efficiency of administration of a drug ion 141 may be prevented by suppressing or preventing an increase in concentration of the first electrolytic ion 121 in the drug solution holding portion 140, and concern about safety arising out of the transfer of the electrolytic ion 121 to the organism may be reduced.

In some embodiments, the transport number of the first ion exchange membrane 130C may be in a range in which the transfer of the second electrolytic ion 122 to the drug solution holding portion 140 upon non-energization may be sufficiently prevented and the transfer of the drug counter ion 142 to the electrolyte solution holding portion 120 occurs to the extent that energization property necessary for the administration of a drug may be secured upon energization. When sufficient energization property may be secured only by the transfer of the drug counter ion 142, the transport number of the second ion exchange membrane 130A may be set to as high a value as possible.

In some embodiments, transport number of the first ion exchange membrane 130C may be in the range of, for example, 0.7 to 0.9, and the transport number of the second ion exchange membrane 130A may be in the range of, for example, 0.9 to 1.0.

In some embodiments, the first ion exchange membrane 130C may be placed on a front surface side, e.g., facing toward the skin of a user, of the second ion exchange membrane 130A.

In some embodiments, the transfer of the drug counter ion 142 from the drug solution holding portion 140 to the electrolyte solution holding portion 120 and/or the transfer of the first electrolytic ion 121 from the electrolyte solution holding portion 120 to the drug solution holding portion 140 facilitates the energization to the drug solution holding portion. When the transport number of each of the first and second ion exchange membranes 130C, 130A, respectively, has a high value close to 1, sufficient energization to the drug solution holding portion might not be secured in some cases because the movement of these ions may be strongly restricted.

In some embodiments, the first ion exchange membrane 130C may be placed on a front surface side, e.g., facing toward the skin of a user, of the second ion exchange membrane 130A. Such a configuration may to facilitate energization of the drug solution holding portion when the respective transport number of the first and second ion exchange membranes 130C, 130A, respectively, may be high. In such a configuration, electrolysis of water at the interface between the first and second ion exchange membranes 130C, 130A, respectively, may easily occur and the transfer of an H⁺ ion and an OH⁻ ion generated by the electrolysis to the electrolyte solution holding portion 120 and the drug solution holding portion 140 enables necessary energization property to be secured.

However, as the concentrations of an H⁺ ion and an OH⁻ ion in the drug solution holding portion 140 increase, these ions compete with the drug ion 141. As a result, the efficiency of administration of a drug reduces, and a problem such as a fluctuation in pH value at a skin interface may occur.

In some embodiments, energization to the drug solution holding portion 140 may be secured by the transfer of the first electrolytic ion 121 to the drug solution holding portion 140 and/or the transfer of the drug counter ion 142 to the electrolyte solution holding portion 120. It may be preferable to prevent the electrolysis of water as long as energization due to the movement of those ions may be secured.

Even when the first ion exchange membrane 130C may be placed on the front surface side of the second ion exchange membrane 130A, energization to the drug solution holding portion 140 due to the transfer of the drug counter ion 142 or the first electrolytic ion 121 may be secured and, at the same time, the electrolysis of water at the interface between the first and second ion exchange membranes 130C, 130A, may be suppressed as long as the transport number of the first ion exchange membrane 130C or the second ion exchange membrane 130A may be reduced to some extent.

In some embodiments, the second ion exchange membrane 130A may be placed on a front surface, e.g., facing toward the skin of a user, of the first ion exchange membrane 130C.

Electrolysis of water at the interface between the first and second ion exchange membranes 130C, 130A, respectively, may be suppressed in the case where energization to the drug solution holding portion 140 may be secured by the transfer of the first electrolytic ion 121 to the drug solution holding portion 140 and/or the transfer of the drug counter ion 142 to the electrolyte solution holding portion 120. The electrolysis of water may be effectively suppressed by having the second ion exchange membrane 130A placed on the front surface of the first ion exchange membrane 130C.

In some embodiments, a spacer layer dividing the first ion exchange membrane 130C from the second ion exchange membrane 130A may be placed between the first ion exchange membrane 130C and the second ion exchange membrane 130A.

As described above, the electrolysis of water may occur at the interface between the first and second ion exchange membranes 130C, 130A, respectively, depending on the transport number and placement of each of the membranes. In addition thereto, a salt of the first electrolytic ion 121 and the drug counter ion 142 may be precipitated at the interface between the first and second ion exchange membranes 130C, 130A, respectively, depending on, for example, the transport number of each of the first and second ion exchange membranes 130C, 130A, respectively, the kind and concentration of each of the first electrolytic ion 121 and the drug counter ion 142, and an energization condition. The precipitation of the salt may have an undesirable influence on the property of administering a drug.

For situations in which the precipitation described above may occur, the first and second ion exchange membranes 130C, 130A, respectively, may be separated from each other by a spacer layer composed of a porous membrane or gel membrane capable of permitting the passage of an ion, whereby the electrolysis of water and the precipitation of a salt at the interface between the first and second ion exchange membranes 130C, 130A, respectively, may be effectively prevented.

In some embodiments, a porous separation membrane that blocks the passage of a molecule of the electrolyte of the electrolyte solution holding portion 120 and/or a drug molecule may be placed between the electrolyte solution holding portion 120 and the drug solution holding portion 140.

The inventors of the instant application have found that, when the active assembly 105 shown in FIGS. 2A and 2B may be retained for a certain time period or longer, a reduction in efficiency of administration of a drug, the alteration of the drug, or the decomposition of the drug in the electrolyte solution holding portion may occur as a phenomenon independent of the above-described phenomenon resulting from the transfer of the second electrolytic ion to the drug solution holding portion (such as the color change of the drug solution, the precipitation of a crystal in the drug solution holding portion, or a reduction in drug effect or the production of a poisonous substance due to the alteration of the drug) depending on the kind of an electrolyte, the kind of the drug, or a combination of them.

In some embodiments, a porous separation membrane that blocks passage of a molecule of the electrolyte and/or a molecule of the drug placed between the electrolyte solution holding portion 120 and the drug solution holding portion 140 may help suppress or prevent each of the observed phenomena.

Furthermore, the inventors of the instant application have found that when any one of above observed phenomena occurs in the active assembly 105 shown in FIGS. 2A and 2B, the first electrolytic ion 121 or the drug ion 141 that should be unable to pass the second ion exchange membrane 130A transfers to the drug solution holding portion 140 or the electrolyte solution holding portion 120, respectively, with time, or the second electrolytic ion 122 that should be unable to pass the first ion exchange membrane 130C transfers to the drug solution holding portion 140. It has been further observed that even for situations where each of the first and second ion exchange membranes 130C, 130A have respective high transport numbers or respective high ion exchange capacities they may be unable to suppress the transfer of each of the above ions with time in some cases.

Accordingly, the transfer of an electrolyte molecule or drug molecule present in an undissociated state to the drug solution holding portion 140 or the electrolyte solution holding portion 120 without being restricted by the first ion exchange membrane 130C may be responsible for the above phenomena. In some embodiments of the iontophoresis device 100 shown in FIGS. 2A and 2B, the above observed phenomena may be prevented by blocking the transfer of the undissociated molecule with a porous separation membrane.

The porous separation membrane (also referred to as an ultrafiltration membrane or a microfiltration membrane) blocks the passage of a molecule having at least a certain molecular weight. The porous separation membrane has a large number of small pores formed in a thin film through which molecules with the certain molecular weight or more cannot pass. A porous separation membrane having a small pore with an appropriate size capable of effectively blocking the passage of an electrolyte molecule or a drug molecule and of permitting the passage of the first electrolytic ion 121 or the drug counter ion may be used.

A porous separation membrane composed of a material such as: a porous membrane composed of a polymer material such as a polysulfone-based, polyacrylonitrile-based, cellulose acetate-based, polyamide-based, polycarbonate-based, or polyvinyl alcohol-based material; or a porous membrane composed of a ceramic-based material such as alumina may be used for the porous separation membrane.

A molecular weight cut-off may be used as an indication of the molecular weight of a molecule or ion that cannot pass the porous separation membrane. A porous separation membrane having a molecular weight cut-off larger than the molecular weight of the first electrolytic ion 121 or the drug counter ion 142 and smaller than the molecular weight of an electrolyte molecule or a drug molecule may be used as the porous separation membrane.

It should be noted that the molecular weight cut-off may be calculated as a molecular weight at which a rejection in a cutoff curve obtained by plotting a rejection R with respect to multiple marker molecules having different molecular weights (the rejection R is defined as 1−Cp/Cb (where Cb represents the concentration of a solute on the side of a supplied liquid via a membrane and Cp represents the concentration of the solute on the side of a transmitted liquid)) is 90%. When the molecular weight cut-off of the porous separation membrane to be used in the present invention is close to the molecular weight of the first electrolytic ion 121 or the drug counter ion 142, or to the molecular weight of the electrolyte molecule or the drug molecule, the degree to which the time period in which the active assembly may be retained without the occurrence of: a slight reduction in energization property upon drug administration; a reduction in efficiency of administration of a drug; or the decomposition of the drug in the electrolyte solution holding portion 120 may be prolonged may be small.

In addition, the passage property of a molecule or an ion with respect to the porous separation membrane may be affected by the steric shape or the like of the molecule or the ion. Therefore, although the molecular weight cut-off may be an important indication for selecting a porous separation membrane, even the selection of a porous separation membrane having a molecular weight cut-off sufficiently large as compared to the molecular weight of the first electrolytic ion 121 or the drug counter ion 142 and sufficiently small as compared to the molecular weight of the electrolyte molecule or the drug molecule may reduce the degree to which the time period in which the active assembly may be retained without the occurrence of: a slight reduction in energization property upon drug administration; a reduction in efficiency of administration of a drug; or the decomposition of the drug in the electrolyte solution holding portion 120 may be prolonged.

Therefore, the porous separation membrane may be selected by: prototyping an active assembly using a porous separation membrane having a molecular weight cut-off in the range of the molecular weight of the first electrolytic ion 121 or the drug counter ion 142 to the molecular weight of the electrolyte molecule or the drug molecule, or close to the range; and experimentally confirming the degree to which the time period in which the active assembly may be retained may be prolonged and the energization property of the active assembly.

The term “blocking of the passage of a molecule or an ion” in the foregoing does not always mean complete blocking. For example, the term includes the case where the transfer of an electrolyte molecule or a drug molecule may be restricted to the extent that an active assembly may be retained without the occurrence of: a reduction in efficiency of administration of a drug; or the decomposition of the drug in an electrolyte solution holding portion 120 over a time period necessary for use even when the electrolyte molecule or the drug molecule transfers with some degree of speed. Similarly, the term “permission of the passage of a molecule or an ion” does not mean a state where no restrictions are imposed on the passage of the molecule or the ion. For example, the term includes the case where the passage of the first electrolytic ion 121 and the drug counter ion 142 may be secured to the extent that energization property of such magnitude that no hitch in terms of use occurs may be expressed even when the passage speeds of these ions reduce to some extent.

In some embodiments, an electrolyte solution into which two or more kinds of electrolytes are dissolved may be used for the electrolyte solution holding portion 120, and a drug solution into which two or more kinds of drugs are dissolved may be used for the drug solution holding portion. Furthermore, some electrolytes to be held by the electrolyte solution holding portion 120 may not affect the efficiency of administration of a drug even when they transfer to the drug solution holding portion, and some drugs to be held by the drug solution holding portion 140 may not produce a harmful substance as a result of decomposition even when they transfer to the electrolyte solution holding portion 120. In such cases, it may be sufficient to use a porous separation membrane capable of blocking only the transfer of: an electrolyte molecule reducing the efficiency of administration of a drug upon transfer to the drug solution holding portion; and a drug molecule that decomposes when being energized to produce a harmful substance.

In some embodiments, the electrolyte solution holding portion 120 or the drug solution holding portion 140 may be constituted to be sealed by using a porous separation membrane formed in a bag shape as the porous separation membrane.

Such a configuration may provide some of the following additional effects. That is, convenience in the storage and conveyance of the electrolyte solution holding portion 120 or the drug solution holding portion 140, and the workability upon assembly of the active assembly 105 are improved. Furthermore, mixing of the electrolyte solution and the drug solution at the end face of each of the electrolyte solution holding portion 120 and the drug solution holding portion 140 may be easily and surely prevented.

In some embodiments, the first or second ion exchange membrane 130C, 130A, respectively, may be constituted to block the passage of an electrolyte molecule or a drug molecule instead of the placement of the porous separation membrane.

A porous film having a small pore filled with an ion exchange resin may be used for each of the first and second ion exchange membranes. When the first or second ion exchange membrane 130C, 130A, respectively, of such type may be used, the use of the first ion exchange membrane 130C and/or the second ion exchange membrane 130A having a small pore, the filling ratio of an ion exchange resin, and the like appropriately selected may permit the passage of the first electrolytic ion 121 or the drug counter ion 142 while blocking the passage of the electrolyte molecule or the drug molecule. The use may also achieve the same action and effect as those of the invention according to claim 6.

In each of the above-described embodiments, a drug may be administered in a state where the drug solution holding portion 140 (for example, a thin-film carrier such as a gauze impregnated with a drug solution may be used as the drug solution holding portion) is brought into direct contact with an organism. A third ion exchange membrane with an ion exchange group of the first polarity type introduced thereto may be placed on the front surface side, e.g., toward the organism, of the drug solution holding portion 140 so that a drug may be administered through the third ion exchange membrane. With this configuration, the transfer of the drug counter ion 142 to the drug solution holding portion 140 may be blocked, and an additional increase in efficiency of administration of the drug may be achieved.

In some embodiments, the first and third ion exchange membranes may form a bag-shaped body, and the drug solution holding portion 140 may be sealed in the bag-shaped body. For such embodiments, at least some of the following additional effects may be obtained. That is, convenience in the storage and conveyance of the drug solution holding portion, and the workability upon assembly of the working assembly are improved. Furthermore, mixing of the electrolyte solution and the drug solution at the end face of each of the electrolyte solution holding portion 120 and the drug solution holding portion 140 may be easily and surely prevented.

In some embodiments, a counter-balance assembly may be provided with two electrolyte solution holding portions 120 (second and third electrolyte solution holding portions) holding electrolyte solutions different from each other in composition. An iontophoresis device capable of preventing a change in composition of the electrolyte solution of each of both the electrolyte solution holding portions may be realized by placing a fourth ion exchange membrane with an ion exchange group of the second polarity type introduced thereto and a fifth ion exchange membrane with an ion exchange membrane of the first polarity type introduced thereto between the two electrolyte solution holding portions.

The same membranes as those described above with respect to the first and second ion exchange membranes may be used for the fourth and fifth ion exchange membranes. Alternatively, a spacer layer dividing the first and second ion exchange membranes from each other may be further placed between the fourth and fifth ion exchange membranes. Alternatively, a porous separation membrane that blocks the passage of electrolyte molecules of both the electrolyte solution holding portions may be further placed between both the electrolyte solution holding portions. Alternatively, a sixth ion exchange membrane with an ion exchange group of the second polarity type introduced thereto may be further placed on the front surface side of the third electrolyte solution holding portion.

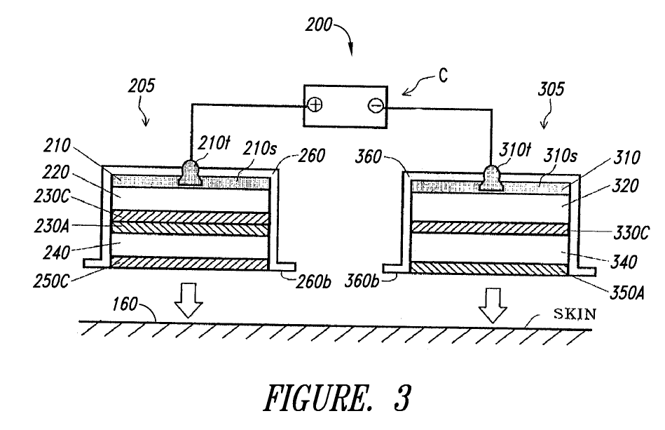

FIG. 3 is a schematic sectional view of another iontophoresis device according to one non-limiting illustrated embodiment.

In the description bellow, the in some embodiments will be discussed in terms of an iontophoresis device for administering a drug whose drug component dissociates into positive charge drug ions, cations, (for example, lidocaine hydrochloride that is an anesthetic agent or morphine hydrochloride that is an anesthetic agent). In the case of an iontophoresis device for administering a drug whose drug component dissociates into negative drug ions, anions, (for example, ascorbic acid that is a vitamin agent), the polarity (plus and negative) of each of an electric power source, each electrode member, and each ion exchange membrane in the following description may be reversed.

As shown in the FIG. 3, the iontophoresis device 200 includes an active assembly 205, a counter-balance assembly 305, and an electric power source C.

The active assembly 205 includes an electrode member 210 connected to the positive pole of the electric power source C, an electrolyte solution holding portion 220 kept so as to be in contact with the electrode member 210, a cation exchange membrane 230C placed on the front surface side (skin side) of the electrolyte solution holding portion 220, an anion exchange membrane 230A placed on the front surface side of the cation exchange membrane 230C, a drug solution holding portion 240 placed on the front surface side of the anion exchange membrane 230A, and a cation exchange membrane 250C placed on the front surface side of the drug solution holding portion 240. The entire active assembly 205 may be housed in a cover or a container 260 composed of a material such as a resin film or a plastic.

The counter-balance assembly 305 includes an electrode member 310 connected to the negative pole of the electric power source C, an electrolyte solution holding portion 320 kept so as to be in contact with the electrode member 310, a cation exchange membrane 330C placed on the front surface side of the electrolyte solution holding portion 320, an electrolyte solution holding portion 340 placed on the front surface side of the cation exchange membrane 330C, and an anion exchange membrane 350A placed on the front surface side of the electrolyte solution holding portion 340. The entire counter-balance assembly 305 may be housed in a cover or a container 360 composed of a material such as a resin film or a plastic.

In some embodiments, the iontophoresis device 200 may include a conductive material that may be used for each of the electrode members 210 and 310 without any particular limitation. In general, an active electrode made of silver/silver chloride or the like capable of preventing electrolysis of water near each of the electrodes 210 and 310 may be used.

In some embodiments, the iontophoresis device 200 may employ an electrolyte solution or buffer electrolyte solution having a low oxidation-reduction potential in each of the electrolyte solution holding portions 220 and 320 that may suppress electrolysis of water and a fluctuation in pH value due to the electrolysis. In addition, the transfer of an H⁺ ion or an OH⁻ ion to the drug solution holding portion 240 or the electrolyte solution holding portion 340 may be blocked by the anion exchange membrane 230A or the cation exchange membrane 330C. Accordingly, in some embodiments, the iontophoresis device 200 may employ an inactive electrode made of silver, platinum, carbon, or the like without a hitch. In particular, composite carbon electrodes 210 and 310 having terminal portions 210t and 310t obtained by mixing a polymer matrix with carbon and conductive sheet portions 210s and 310s attached to the terminal portions 210t and 310t and made of a carbon fiber or carbon fiber paper may be suitably used for the iontophoresis device 200 as electrodes excellent in following property with respect to a skin and uniformity in a current density and capable of eliminating the possibility that a metal ion transfers to an organism.

The electrolyte solution holding portions 220, 320, and 340 in the iontophoresis device 200 are intended for holding an electrolyte solution so as to keep conductivity. Phosphate buffered saline, physiological saline, or the like may be used as the electrolyte solution typically.

Furthermore, in order to suppress or prevent the generation of a gas caused by the electrolytic reaction of water and an increase in conductive resistance caused by the generation of a gas, or a change in pH caused by the electrolytic reaction of water with improved effectiveness, an electrolyte that may be more likely to be oxidized or reduced than the electrolytic reaction (oxidation at the positive pole and the reduction at the negative pole) of water may be added to the electrolyte solution holding portions 220 and 320. In terms of biological safety and economic efficiency (low cost and easy availability), for example, an inorganic compound such as ferrous sulfate or ferric sulfate, a medical agent such as ascorbic acid (vitamin C) or sodium ascorbate, and an organic acid such as lactic acid, oxalic acid, malic acid, succinic acid, or fumaric acid and/or a salt thereof may be used. Alternatively, a combination of those substances such as a mixed aqueous solution of lactic acid and sodium fumarate may also be used.

Each of the electrolyte solution holding portions 220, 320, and 340 may hold the above-mentioned electrolyte solution in a liquid state. However, each of the electrolyte solution holding portions 220, 320, and 340 may be constituted by impregnating a water-absorbing thin-film carrier made of a polymer material or the like with the above-mentioned electrolyte solution, thereby enhancing the handleability thereof. The same thin-film carrier as that may be used in the drug solution holding portion 240 may be used as the thin-film carrier used herein. Therefore, the detail thereof will be described together in the following description regarding the drug solution holding portion 240.

The drug solution holding portion 240 in the iontophoresis device 200 holds, as a drug solution, an aqueous solution of a drug that dissociates into a positive charge drug ion responsible for a drug effect and a negative drug counter ion 142 as a counter ion of the positive charge drug ion as a result of dissolution.

The drug solution holding portion 240 may hold a drug solution in a liquid state. However, it may be also possible to impregnate such water-absorbing thin-film carrier as described below with a drug solution so that the handleability or the like thereof may be enhanced.

Examples of a material that may be used for the water-absorbing thin-film carrier in this case include a gel membrane composed of an acrylhydrogel or a segmented polyurethane-based gel as well as a gauze and filter paper. High drug delivery property may be obtained by impregnating the above aqueous solution at an impregnation ratio of 20 to 60 wt %.

The above-mentioned acrylhydrogel (for example, available from Sun Contact Lens Co., Ltd.) may be a gel having a three-dimensional network structure (cross-linking structure). When the above aqueous solution is added to the acrylhydrogel, the acrylhydrogel becomes a polymer adsorbent having ion conductivity. Furthermore, the impregnation ratio of the acrylhydrogel may be adjusted depending on the size of the three-dimensional network structure and the kind and ratio of a monomer constituting a resin. The acrylhydrogel with an impregnation ratio of 20 to 60% may be prepared from 2-hydroxyethyl methacrylate and ethylene glycol dimethacrylate (monomer ratio 98 to 99.5:0.5 to 2).

Furthermore, the segmented polyurethane-based gel has, as segments, polyethylene glycol (PEG) and polypropylene glycol (PPG), and may be prepared by means of a monomer and diisocyanate constituting these segments. The segmented polyurethane-based gel has a three-dimensional structure cross-linked by a urethane bond, and the impregnation ratio and adhesion strength of the gel may be easily adjusted by controlling the size of a network, and the kind and ratio of a monomer in the same way as in the acrylhydrogel.

An ion exchange membrane with a cation exchange group introduced thereto such as a NEOSEPTA (CM-1, CM-2, CMX, CMS, or CMB) manufactured by Tokuyama Co., Ltd may be used for each of the cation exchange membranes 230C, 250C, and 330C in the iontophoresis device 200. An ion exchange membrane with an anion exchange group introduced thereto such as a NEOSEPTA (AM-1, AM-3, AMX, AHA, ACH, or ACS) manufactured by Tokuyama Co., Ltd may be used for each of the anion exchange membranes 230A and 350A.

Known examples of an ion exchange membrane include various ion exchange membranes such as (1) a heterogenenous ion exchange membrane obtained by: dispersing an ion exchange resin into a binder polymer; and forming the resultant into a membrane through, for example, molding under heat and (2) a homogeneous ion exchange membrane obtained by: impregnating a base material such as cloth, a net, or a porous film with a solution prepared by dissolving a composition composed of a monomer, a cross-linkable monomer, a polymerization initiator, or the like into which an ion exchange group may be introduced or a resin having a functional group into which an ion exchange group may be introduced into a solvent; subjecting the resultant to polymerization or solvent removal; and subjecting the resultant to a treatment for introducing an ion exchange group as well as an ion exchange resin formed into a membrane-like shape. Those ion exchange membranes may be used for the cation exchange membranes 230C, 250C, and 330C, and the anion exchange membranes 230A and 350A without any particular limitation.

Examples of a cation exchange group to be introduced to each of the cation exchange membranes 230C, 250C, and 330C include a sulfonic group, a carboxylic group, and a phosphoric group. The transport number of an ion exchange membrane may be controlled depending on the kind of a cation exchange group to be introduced. For example, the use of a sulfonic group as a strong acidic group provides a cation exchange membrane having a high transport number.

Examples of an anion exchange group to be introduced to each of the anion exchange membranes 230A and 350A include a primary amino group, a secondary amino group, a tertiary amino group, a quaternary ammonium group, a pyridyl group, an imidazole group, a quaternary pyridinium group, and a quaternary imidazolium group. The transport number of an ion exchange membrane may be controlled depending on the kind of an anion exchange group to be introduced. For example, the use of a quaternary ammonium group or a quaternary pyridinium group as a strong basic group provides an anion exchange membrane having a high transport number.

Known examples of a treatment for introducing a cation exchange group include various approaches such as sulfonation, chlorosulfonation, phosphonation, and hydrolysis. Known examples of a treatment for introducing an anion exchange group include various approaches such as amination and alkylation. The ion exchange capacity and transport number of an ion exchange membrane may be adjusted by adjusting conditions under which a treatment for introducing an ion exchange group may be performed.

In addition, the ion exchange capacity and transport number of an ion exchange membrane may be adjusted depending on, for example, the amount of an ion exchange resin in the ion exchange membrane and the pore size of the membrane. For example, in the case of an ion exchange membrane of a type in which a porous film may be filled with an ion exchange resin, an ion exchange membrane obtained by filling a porous film with an ion exchange resin at a filling ratio of 5 to 95 mass %, or in some embodiments, 10 to 90 mass %, and in yet other embodiments, 20 to 60 mass % may be used, the porous film having formed thereon a large number of small pores having a mean pore size of preferably 0.005 to 5.0 μm, or in some embodiments, 0.01 to 2.0 μm, or most preferably 0.02 to 0.2 μm (a mean flow pore size measured in conformance with the bubble point method (JIS K3832-1990)) at a porosity of preferably 20 to 95%, more preferably 30 to 90%, or in other embodiments, 30 to 60% and having a thickness of preferably 5 to 140 μm, or in yet other embodiments, 10 to 120 μm, or in yet other embodiments 15 to 55 μm. The ion exchange capacity or the transport number may be adjusted depending also on the mean pore size of the small pores of the porous film, the porosity, and the filling ratio of the ion exchange resin.

A membrane having as high a transport number as possible may be used for the cation exchange membrane 250C in the iontophoresis device 200. For example, the use of the cation exchange membrane 250C having a transport number of 0.8 or more, or in some embodiments, 0.95 or in some embodiments 0.98 or more may suppress the transfer of a biological counter ion to the drug solution holding portion 240 and realize the efficient administration of a drug ion.

In some cases, electrolyte solutions different from each other in composition are used for the electrolyte solution holding portions 320 and 340. For example, a mixed aqueous solution of ascorbic acid and polyacrylic acid may be used as the electrolyte solution of the electrolyte solution holding portion 320 for effectively suppressing the electrolysis of water and a fluctuation in pH, and physiological saline may be used as the electrolyte solution of the electrolyte solution holding portion 340 for enhancing safety with respect to an organism. In such case, a membrane having as high a transport number as possible may be used for the cation exchange membrane 330C. For example, the use of the cation exchange membrane 330C having a transport number of 0.8 or more, or in some embodiments 0.95 or more, or in some embodiments 0.98 or more may prevent a change in composition of the electrolyte solution of each of both the electrolyte solution holding portions 320 and 340 during the time period in which the device may be retained and prevent a negative ion in the electrolyte solution holding portion 320 from transferring to the electrolyte solution holding portion 340 during administration of a drug.

The transport number of the cation exchange membrane 250C is a ratio of charge conveyed as a result of the passing of a positive charge ion in the drug solution holding portion 240 through the cation exchange membrane 250C to the total charge conveyed through the cation exchange membrane 250C upon energization. The transport number of the cation exchange membrane 330C is a ratio of charge conveyed as a result of the passing of a positive charge ion in the electrolyte solution holding portion 340 through the cation exchange membrane 330C to the total charge conveyed through the cation exchange membrane 330C upon energization. As described above, the transport number may be adjusted depending on, for example, the kind of an ion exchange group to be introduced to an ion exchange resin, conditions under which the group is introduced, the mean pore size and porosity of a porous film, and the filling ratio of the ion exchange resin.

The transport number of at least one of the cation exchange membrane 230C and the anion exchange membrane 230A may be reduced to some extent. For example, the transport number may be in the range of 0.7 to 0.95. When the transport number is in this range, the transfer of a drug counter ion 142 to the electrolyte solution holding portion 220 or the transfer of a positive charge ion in the electrolyte solution holding portion 220 to the drug solution holding portion 240 upon energization may be allowed to occur easily, and an energization amount necessary for the administration of a drug may be secured.

Even when the transport number of the anion exchange membrane 230A may be set to a relatively low value (about 0.7 to 0.95), the transfer of a drug ion to the electrolyte solution holding portion 220 upon non-energization may be sufficiently prevented. Therefore, as in the case of a conventional iontophoresis device, the transfer of the drug ion to the electrolyte solution holding portion 220 during the time period in which the device may be retained, or the decomposition of a drug that has transferred to the electrolyte solution holding portion 220 upon energization may be prevented.

Furthermore, in some embodiments, the cation exchange membrane 230C may be placed between the electrolyte solution holding portion 220 and the drug solution holding portion 240. Therefore, the transfer of the second electrolytic ion 122 to the drug solution holding portion 240 during the time period in which the device may be retained may be suppressed, and hence the device may be retained over a long time period without the occurrence of a phenomenon such as the color change of a drug, the precipitation of a crystal in the drug solution holding portion, a reduction in drug effect, or the production of a harmful substance due to the alteration of the drug. Even when the transport number of the cation exchange membrane 230C may be set to a relatively low value (about 0.7 to 0.95), the transfer of a negative ion in the electrolyte solution holding portion 220 to the drug solution holding portion 240 upon non-energization may be sufficiently prevented. Therefore, the device may be retained over a long time period without the occurrence of each of the above phenomena.

When the electrolyte solution holding portion 220 contains a positive charge ion having a small molecular weight and hence a mobility comparable to or larger than that of a drug ion such as Na⁺, or a positive charge ion which is not preferably transferred to an organism from the viewpoint of safety or the like, the transport number of the cation exchange membrane 230C may be reduced to some extent while the transport number of the anion exchange membrane 230A may be set to as high a value as possible. In this case, the transfer of the positive charge ion in the electrolyte solution holding portion 220 to the drug solution holding portion 240 may be effectively prevented by the anion exchange membrane 230A while energization to the drug solution holding portion 240 upon administration of a drug may be mainly secured by the transfer of the drug counter ion 142 to the electrolyte solution holding portion 220. As a result, a reduction in efficiency of administration of a drug may be prevented, or concern about the safety of an organism may be eliminated.

In this case, the transport number of the cation exchange membrane 230C may be, for example, 0.7 to 0.95, and the transport number of the anion exchange membrane 230A may be 0.9 or more, or in some embodiments 0.95 or more, or in some embodiments 0.98 or more.

The cation exchange membrane 230C and the anion exchange membrane 230A having such appropriate transport numbers as described above may be obtained by appropriately selecting, for example, the kind of an ion exchange group to be introduced to each membrane, conditions under which the group is introduced, the mean pore size of small pores of a porous film, the porosity, and the filling ratio at which the porous film may be filled with an ion exchange resin.

In the above description, the transport number of the cation exchange membrane 230C is a ratio of charge conveyed as a result of the passing of a positive charge ion in the electrolyte solution holding portion 220 through the cation exchange membrane 230C to the total charge conveyed through the cation exchange membrane 230C when a positive polarity voltage is applied to the electrode member 210 in a state where only the cation exchange membrane 230C may be placed between the electrolyte solution holding portion 220 and the drug solution holding portion 240. The transport number of the anion exchange membrane 230A is a ratio of charge conveyed as a result of the passing of a negative ion (mainly a drug counter ion) in the drug solution holding portion 240 through the anion exchange membrane 230A to the total charge conveyed through the anion exchange membrane 230A when a positive polarity voltage is applied to the electrode member 210 in a state where only the anion exchange membrane 230A may be placed between the electrolyte solution holding portion 220 and the drug solution holding portion 240.

Even when the cation exchange membrane 230C and the anion exchange membrane 230A having such appropriate transport numbers as described above are used, an electrolyte molecule in the electrolyte solution holding portion 220 may transfer to the drug solution holding portion 240 during the time period in which the device may be retained, to thereby cause the alteration of a drug or a reduction in efficiency of administration depending on the kind of the electrolyte in the electrolyte solution holding portion 220 and/or the kind of the drug in the drug solution holding portion 240. In addition, an undissociated drug molecule may transfer to the electrolyte solution holding portion 220 during the time period in which the device may be retained, to thereby cause the decomposition of the drug near the electrode member 210 upon energization.

In such case, an ion exchange membrane having molecular weight cut-off property capable of blocking the passage of the electrolyte molecule or the drug molecule and of permitting the passage of the drug counter ion 142 or a positive charge ion in the electrolyte solution holding portion 220 may be used for at least one of the cation exchange membrane 230C and the anion exchange membrane 230A. As a result, the decomposition of a drug near the electrode member 210, a reduction in efficiency of administration of a drug ion, or the alteration of a drug upon administration of the drug after the device has been retained for a long time period may be prevented.

When an ion exchange membrane of a type in which a porous film having a large number of small pores communicating both sides of the film may be filled with an ion exchange resin may be used, such appropriate molecular weight cut-off property as described above may be imparted to the ion exchange membrane by appropriately adjusting, for example, the size of each of the small pores and the amount of the ion exchange resin with which the film may be to be filled.

The cover or container 260 or 360 in the active assembly 205 or the counter-balance assembly 305 may be formed of an arbitrary material such as a plastic capable of preventing: the evaporation of water from each of the electrolyte solution holding portions 220, 320, and 340, and the drug solution holding portion 240; and the mixing of foreign matter from the outside. An adhesive layer for improving adhesiveness to a skin may be arranged on a bottom portion 260b or 360b of the cover or container.

A battery, a constant voltage device, a constant current device, a constant voltage/current device, or the like may be used as the electric power source C in the iontophoresis device 200. It may be preferable to use a constant current device whose current may be adjusted in the range of 0.01 to 1.0 mA/cm², or in some embodiments, 0.01 to 0.5 mA/cm², and which operates under safe voltage conditions, specifically at 50 V or less, or in some embodiments, 30 V or less.

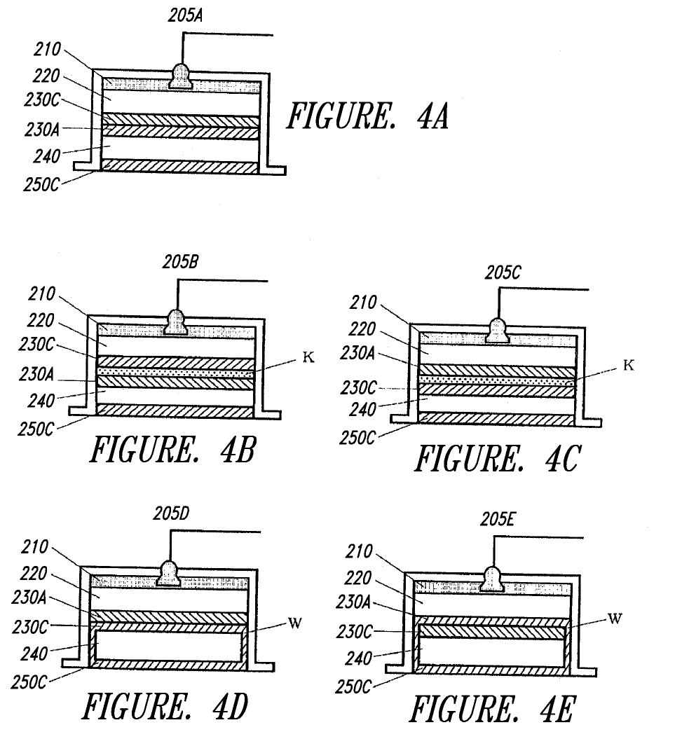

FIGS. 4A-4E are plan views of various embodiments of active assembly 205 according to respective illustrated embodiments.

The active assembly 205A shown in FIG. 4A has similar or essentially similar elements as that of the active assembly 205 except that the anion exchange membrane 230A may be placed on the front surface side of the electrolyte solution holding portion 220 and the cation exchange membrane 230C may be placed on the front surface side of the anion exchange membrane. An iontophoresis device obtained by replacing the active assembly 205 with the active assembly 205A achieves the same action and effect as those of the iontophoresis device 200 described above. In addition, the iontophoresis device may cause the electrolysis of water at an interface between the anion exchange membrane 230A and the cation exchange membrane 230C to secure energization to the drug solution holding portion 240 with the aid of the transfer of an H⁺ ion and an OH⁻ ion generated by the electrolysis to the drug solution holding portion 240 and the electrolyte solution holding portion 220, respectively, even when a membrane having a transport number extremely close to 1 must be used for each of the anion exchange membrane 230A and the cation exchange membrane 230C by reason of some circumstances.

In each of the active assemblies 205B and 205C shown in FIGS. 4B and 4C, respectively, the cation exchange membrane 230C and the anion exchange membrane 230A in each of the active assemblies 205B and 205C are divided from each other by a spacer layer K composed of a porous membrane or gel membrane capable of permitting the passage of at least a drug counter ion 142 or a positive charge ion in the electrolyte solution holding portion 220. As a result, the electrolysis of water and the precipitation of a salt which may occur between the anion exchange membrane 230A and the cation exchange membrane 230C depending on energization conditions may be effectively prevented.

Each of the active assemblies 205D and 205E shown in FIGS. 4D and 4E, respectively, has similar or essentially similar elements as that of the active assembly 205 except that the respective drug solution holding portion 240 may be sealed in a bag-shaped body W constituted by a cation exchange membrane and a part of the bag-shaped body W may be used as each of the cation exchange membranes 230C and 250C. An iontophoresis device obtained by replacing the active assembly 205 with the active assembly 205D or 205E achieves the same action and effect as those of the iontophoresis device 200 described above.

Furthermore, the iontophoresis device provides additional actions and effects. For example, mixing of the electrolyte solution and the drug solution at the end face of each of the electrolyte solution holding portion 220 and the drug solution holding portion 240 may be surely prevented. In addition, the handleability of the drug solution holding portion 240, and the workability upon assembly of each of the active assemblies 205D and 205E are improved.

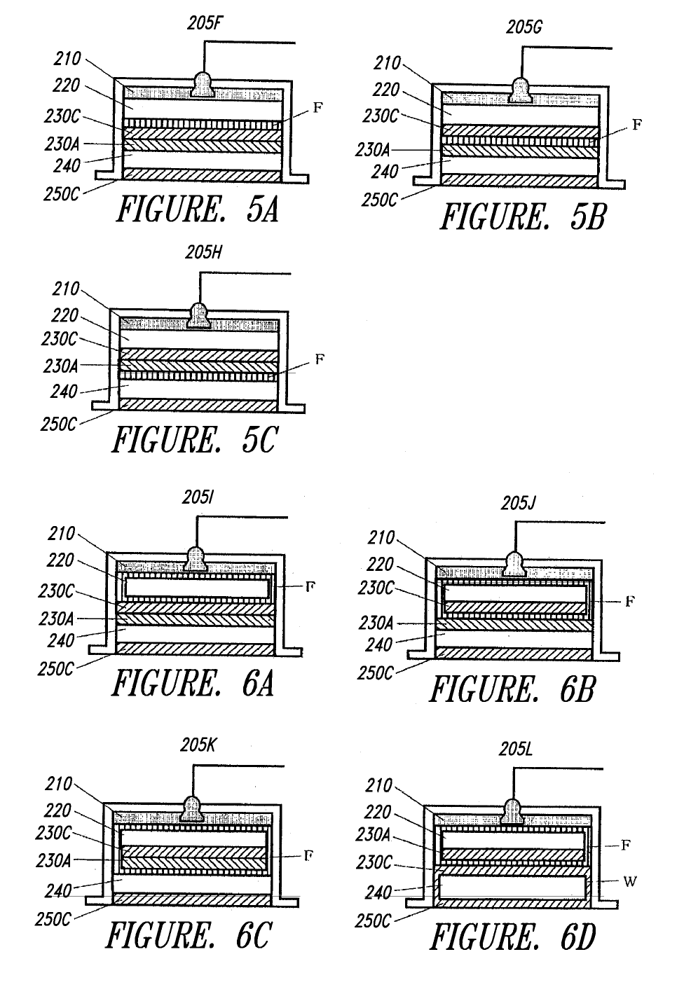

FIGS. 5A-5C are plan views of various embodiments of active assembly 205 according to respective illustrated embodiments.

Each of the active assemblies 205F-205H shown in FIGS. 5A-5C have similar or essentially similar elements as that of active assembly 205 except that a porous separation membrane F is included. The separation membrane F may be may be further placed between the electrolyte solution holding portion 220 and the drug solution holding portion 240. In particular, the separation membrane F may be disposed on the back side (distal from the skin) of the cation exchange membrane 230C (FIG. 5A) or between the cation exchange membrane 230C and the anion exchange member 230A (FIG. 5B) or may be placed on the front surface (proximal to the skin) of the anion exchange member 230A. An iontophoresis device obtained by replacing the active assembly 205 with each of the active assemblies 205F-205H achieves the same action and effect as those of the iontophoresis device 200 described above.

The porous separation membrane F has molecular weight cut-off property capable of permitting the passage of a positive charge ion in the electrolyte solution holding portion 220 or a negative ion in the drug solution holding portion while blocking the passage of an electrolyte molecule held by the electrolyte solution holding portion 220 or a drug molecule held by the drug solution holding portion 240.

For example, when an aqueous solution of sodium fumarate may be used as the electrolyte solution of the electrolyte solution holding portion 220 and an aqueous solution of lidocaine hydrochloride may be used as the electrolyte solution of the drug solution holding portion 240, the use of a porous separation membrane having a molecular weight cut-off of about 50 to 100 (for example, available as NUCLEPORE from Whatman plc or as Por™CE from Spectrum Laboratories, Inc.) as the porous separation membrane F may block the transfer of a sodium fumarate molecule (having a molecular weight of 137) to the drug solution holding portion 240 and the transfer of a lidocaine hydrochloride molecule (having a molecular weight of 268) to the electrolyte solution holding portion 220 during the time period in which the device may be retained while permitting the transfer of a Na⁺ ion in the electrolyte solution holding portion 220 to the drug solution holding portion 240 and the transfer of a Cl⁻ ion in the drug solution holding portion 240 to the electrolyte solution holding portion 220 upon energization.

In addition, the use of a porous separation membrane having a molecular weight cut-off of about 150 to 200 (for example, available as NUCLEPORE from Whatman plc or as Por™CE from Spectrum Laboratories, Inc.) may additionally improve the transfer property of a Na⁺ ion in the electrolyte solution holding portion 220 to the drug solution holding portion 240 and the transfer property of a Cl⁻ ion in the drug solution holding portion 240 to the electrolyte solution holding portion 220 upon energization respectively while blocking the transfer of a lidocaine hydrochloride molecule (having a molecular weight of 268) to the electrolyte solution holding portion 220 as in the case of the foregoing.

FIGS. 6A-6D are plan views of various embodiments of active assembly 205 according to respective illustrated embodiments.

Each of the active assemblies 2051-205K shown FIGS. 6A-6C have similar, or essentially similar, elements as those of the active assemblies 205F-205H except that the electrolyte solution holding portion 220 may be sealed in the porous separation membrane F formed into a bag shape. In particular, the bag shaped porous separation membrane F may be: on the back side of the cation exchange membrane 230C (FIG. 6A); on the back side of the anion exchange membrane 230A having the cation exchange membrane 230C therein (FIG. 6B); and distal from the cation exchange membrane 250C having both the cation exchange membrane 230C and the anion exchange membrane 230A therein. An iontophoresis device including any of the active assemblies 2051-205K achieves the same action and effect as those of the above-described iontophoresis device including each of the active assemblies 205F-205H.

Furthermore, the iontophoresis device provides additional actions and effects. For example, mixing of the electrolyte solution and the drug solution at the end face of each of the electrolyte solution holding portion 220 and the drug solution holding portion 240 may be surely prevented. In addition, the handleability of the electrolyte solution holding portion 220, and the workability upon assembly of each of the active assemblies 2051-205K are improved.

In each of the active assemblies 2051-205K, the electrolyte solution holding portion 220 may be sealed in the bag-shaped porous separation membrane F. The drug solution holding portion 240 may also be sealed in the bag-shaped porous separation membrane F, and the same action and effect as those in the case of each of the active assemblies 2051-205K are achieved even in this case.

In an active assembly 205L shown in FIG. 6d, the electrode member 210, the electrolyte solution holding portion 220, the anion exchange membrane 230A, and the porous separation membrane F have similar, or essentially similar, elements as those of the active assembly 205J, and parts of the bag-shaped body W constituted by the cation exchange membranes 230C and 250C, and the drug solution holding portion 240 have the same constitutions as those of the active assembly 205D. In particular, the bag shaped porous separation membrane F having the anion exchange membrane 230A therein is on the back side of the bag shaped cation exchange membrane W.

As described above, an iontophoresis device including the electrolyte solution holding portion 220 sealed in the bag-shaped porous separation membrane F and the drug solution holding portion 240 sealed in a bag-shaped cation exchange membrane achieves the same action and effect as those of the iontophoresis device 200. In addition, the iontophoresis device provides additional actions and effects. For example, mixing of the electrolyte solution and the drug solution at the end face of each of the electrolyte solution holding portion 220 and the drug solution holding portion 240 may be surely prevented. In addition, the handleability of each of the electrolyte solution holding portion 220 and the drug solution holding portion 240, and the workability upon assembly of an active assembly are improved.

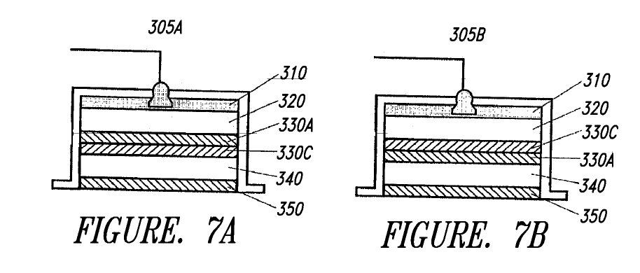

FIGS. 7A and 7B are plan views of various embodiments of counter-balance assembly 305 according to respective illustrated embodiments.

In each of the counter-balance assemblies 305A and 305B, an anion exchange membrane 330A and a cation exchange membrane 330C are placed between the two electrolyte solution holding portions 320 and 340, so a positive charge ion in the electrolyte solution holding portion 320 may be prevented from transferring to the electrolyte solution holding portion 340 during the time period in which the device may be retained. In particular, the anion exchange membrane 330A may be on the back side (distal from the skin) of the cation exchange membrane 330C (FIG. 7A) or the cation exchange membrane 330C may be on the back side (distal from the skin) of the anion exchange membrane 330A (FIG. 7B).

Accordingly, each of the counter-balance assemblies 305A and 305B may be suitably used for an iontophoresis device in which the electrolyte solution holding portions 320 and 340 hold electrolytes different from each other or for an iontophoresis device in which the electrolyte solution holding portion 340 holds a second drug whose drug component dissociates into negative ions.

It should be noted that each of the counter-balance assemblies 305A and 305B may include the spacer layer K and/or the bag-shaped body W and/or the porous separation membrane in the same manner as in each of the active assemblies 205B to 2051.

The above description of illustrated embodiments, including what is described in the Abstract, is not intended to be exhaustive or to limit the embodiments to the precise forms disclosed. Although specific embodiments of and examples are described herein for illustrative purposes, various equivalent modifications can be made without departing from the spirit and scope of the disclosure, as will be recognized by those skilled in the relevant art.

For example, in the above embodiments, the case where the active assembly has the third ion exchange membrane 250C has been described as the most preferable embodiment. However, drug ions may also be administered in a state where the third ion exchange membrane 250C may be omitted, and the drug solution holding portion 240 may be brought into direct contact with an organism.

Similarly, in the above embodiments, the case where each of the counter-balance assemblies 305 to 305B includes the electrode member 310, the electrolyte solution holding portions 320 and 340, and the ion exchange membranes 330C, 330A, and 350A has been described. However, those elements 320, 340, 330C, 330A, and 350A may be omitted. Alternatively, the following may be also possible. No counter-balance assembly may be provided for the iontophoresis device itself, and for example, in a state where a part of an organism may be brought into contact with a member to be the earth while the active assembly may be brought into contact with the skin of the organism, a voltage may be applied to the active assembly to administer a drug. Such iontophoresis device may be inferior to the iontophoresis device 200, for example, in the performance of suppressing a change in pH on the surface of contact between the counter-balance assembly, the earth member, or the like and the skin S. However, the iontophoresis device exhibits the same performance as that of the iontophoresis device 200 in the other points. In particular, the iontophoresis device exhibits the following action and effect peculiar to the present invention: the transfer of the second electrolytic ion 122 to the drug solution holding portion may be blocked, whereby the time period in which the device may be retained without the occurrence of a phenomenon such as the color change, alteration, and decomposition of a drug, and a reduction in efficiency of administration of the drug may be prolonged. Those iontophoresis devices are also included in the scope of the disclosed embodiments.

Furthermore, in each of the above embodiments, the case has been described where the active assembly, the counter-balance assembly, and the electric power source are constituted separately. It may be also possible that those elements are incorporated in a single casing or that an entire device incorporating them may be formed in a sheet shape or a patch shape, whereby the handleability thereof may be enhanced, and such iontophoresis device may be also included in the scope of the disclosed embodiments.

The various embodiments described above may be combined to provide further embodiments. All of the U.S. patents, U.S. patent application publications, U.S. patent applications, foreign patents, foreign patent applications and non-patent publications referred to in this specification and/or listed in the Application Data Sheet, are incorporated herein by reference, in their entirety.

Aspects of the embodiments may be modified, if necessary to employ concepts of the various patents, applications and publications to provide yet further embodiments.

These and other changes may be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. An iontophoresis device comprising:
an electrolyte solution holding portion having a front surface and a back surface, the electrolyte solution holding portion holding a solution of an electrolyte being dissociated into a first electrolytic ion of a first polarity type and a second electrolytic ion of a second polarity type, wherein the first polarity type and the second polarity type are of opposite polarity, wherein in operable position the front surface is proximal to a user and the back surface is distal from the user;
a drug solution holding portion holding a solution of a drug being dissociated a drug ion of the first polarity type and a drug counter ion of the second polarity type, the drug solution holding portion being proximal to the front surface side of the electrolyte solution holding portion; a first ion exchange membrane with an ion exchange group of the first polarity type and a second ion exchange membrane with an ion exchange group of the second polarity type, the first and the second ion exchange members interpose the electrolyte solution holding portion and the drug solution holding portion.

2. The iontophoresis device of claim 1, wherein each of the first and the second ion exchange membrane have a respective transport number and wherein the second ion exchange membrane has a transport number higher than that of the first ion exchange membrane.

3. The iontophoresis device of claim 1 wherein the first ion exchange membrane interposes the second ion exchange membrane and the drug solution holding portion.

4. The iontophoresis device claim 1 wherein the second ion exchange membrane interposes the first ion exchange membrane and the drug solution holding portion.

5. The iontophoresis device of claim 1, further comprising a spacer layer interposing the first ion exchange membrane and the second ion exchange membrane.

6. The iontophoresis device of claim 1, further comprising a porous separation membrane that blocks passage of a molecule of the electrolyte and/or a molecule of the drug interposing the electrolyte solution holding portion and the drug solution holding portion.

7. The iontophoresis device of claim 6, wherein the porous separation membrane is a portion of a sealed porous membrane bag containing at least one of the electrolyte solution holding portion and/or the drug solution holding portion.

8. The iontophoresis device of claim 1 wherein the first ion exchange membrane blocks passage of one of a molecule of the electrolyte or a molecule of the drug and the second ion exchange membrane blocks passage of the other one of the molecule of the electrolyte or the molecule of the drug.

9. The iontophoresis device of claim 1, further comprising a third ion exchange membrane with an ion exchange group of the first conductivity type disposed proximal to a front surface side of the drug solution holding portion, wherein in operable position the front surface side is in contact with the user.

10. The iontophoresis device according to claim 9 wherein the first and third ion exchange membranes are portions of a sealed bag having the drug solution holding portion sealed within an interior of the bag.

11. The iontophoresis device of claim 1, further comprising:
a counter-balance assembly having a second electrolyte solution holding portion holding a solution of a second electrolyte being dissociated into a third electrolytic ion of the first conductivity type and a fourth electrolytic ion of the second conductivity type, and a third electrolyte solution holding portion holding a solution of a third electrolyte that is different from the second electrolyte, which dissociates into a fifth electrolytic ion of the first conductivity type and a sixth electrolytic ion of the second conductivity type in a solution; and
a third ion exchange membrane with the ion exchange group of the second conductivity type and a fifth ion exchange membrane with the ion exchange group of the first conductivity type the third and the fourth ion exchange membrane interposing the second electrolyte solution holding portion and the third electrolyte solution holding portion.

12. The iontophoresis device of claim 11 further comprising a sixth ion exchange membrane with an ion exchange group of the second conductivity type disposed proximal to a front surface side of the third electrolyte solution holding portion, wherein in operable position the front surface side is in contact with the user.

13. The iontophoresis device of claim 8 wherein the second ion exchange membrane blocks passage of both of the molecule of the electrolyte or the molecule of the drug.

14. The iontophoresis device of claim 2 wherein the second ion exchange membrane interposes the first ion exchange membrane and the drug solution holding portion.

15. The iontophoresis device of claim 1 wherein each of the first and the second ion exchange membrane have a respective transport number, and wherein the second ion exchange membrane has a transport number higher than that of the first ion exchange membrane, and wherein the first ion exchange membrane interposes the second ion exchange membrane and the drug solution holding portion.

16. The iontophoresis device of claim 15, further comprising a porous separation membrane that blocks passage of a molecule of the electrolyte and/or a molecule of the drug interposing the electrolyte solution holding portion and the drug solution holding portion.

17. The iontophoresis device of claim 16 wherein the porous separation membrane is a portion of a sealed porous membrane bag containing at least one of the electrolyte solution holding portion and/or the drug solution holding portion.

18. The iontophoresis device of claim 15 wherein the first ion exchange membrane blocks passage of one of a molecule of the electrolyte or a molecule of the drug and the second ion exchange membrane blocks passage of the other one of the molecule of the electrolyte or the molecule of the drug.

19. An iontophoresis device comprising:
an active assembly housing having a generally hollow interior and an opening extending from an exterior of the active assembly housing to the generally hollow interior;
an active assembly electrode electrically carried by the active assembly housing and being couplable to a power source;
an electrolyte in electrical communication with the active assembly electrode and received by a first portion of the generally hollow interior of the active assembly housing, the electrolyte dissociated into a first electrolytic ion of a first polarity type and a second electrolytic ion of a second polarity type, wherein the first polarity type and the second polarity type are of opposite polarity;
a first ion exchange membrane with an ion exchange group of a first polarity type;
a second ion exchange membrane with an ion exchange group of a second polarity type, wherein the first and the second ion exchange members interpose the electrolyte solution and the opening of the active assembly housing; and
a drug solution received by a second portion of the generally hollow interior of the active assembly housing, the drug solution being dissociated into a drug ion of the first polarity type and a drug counter ion of the second polarity type, the drug solution interposing the at least one of the first ion exchange membrane or the second ion exchange membrane and the opening of the active assembly housing.

20. The iontophoresis device of claim 19, further comprising:
an counter-balance assembly housing having a generally hollow interior and an opening extending from an exterior of the counter-balance assembly housing to the generally hollow interior;
an counter-balance assembly electrode electrically carried by the counter-balance assembly housing and being couplable to the power source;
a second electrolyte in electrical communication with the counter-balance assembly electrode and received by a first portion of the generally hollow interior of the counter-balance assembly housing, the second electrolyte being dissociated into a first electrolytic ion of the first polarity type of the second electrolyte and a second electrolytic ion of the second polarity type of the second electrolyte;
a third ion exchange membrane with an ion exchange group of a first polarity type;
a fourth ion exchange membrane with an ion exchange group of a second polarity type, wherein the third and the fourth ion exchange members interpose the second electrolyte solution and the opening of the active assembly housing; and
a third electrolyte received by a second portion of the generally hollow interior of the counter-balance assembly housing, the third electrolyte being dissociated into a first electrolytic ion of the first polarity type of the third electrolyte and a second electrolytic ion of the second polarity type of the third electrolyte, the third electrolyte interposing the at least one of the third ion exchange membrane or the fourth ion exchange membrane and the opening of the counter-balance assembly housing.
